(19) United States
(12) Patent Application Publication
(10) Pub. No.: US 2015/0242582 A1
(43) Pub. Date: Aug. 27, 2015

(54) SYSTEM FOR DISSEMINATING MEDICAL INFORMATION

(71) Applicants: Manish Mehta, Chicago, IL (US); Vishal Mehta, Naperville, IL (US); Syed Akhter, Chicago, IL (US)

(72) Inventors: Manish Mehta, Chicago, IL (US); Vishal Mehta, Naperville, IL (US); Syed Akhter, Chicago, IL (US)

(73) Assignee: MEDICAL WAIT TIME LLC, Chicago, IL (US)

(21) Appl. No.: 13/872,307

(22) Filed: Apr. 29, 2013

Related U.S. Application Data
(60) Provisional application No. 61/641,216, filed on May 1, 2012.

(51) Int. Cl. G06F 19/00; H04L 12/58; H04L 29/06

(52) U.S. Cl. CPC G06F 19/3418; H04L 65/403; H04L 51/24

(57) ABSTRACT

A system configured to disseminate health care information of a patient to individuals to encourage increased patient compliance and improved patient outcome, where the system may include a secure server that enables the individuals to access this information.

### PRIORITY CLAIM

This patent application claims the benefit of U.S. Provisional Application No. 61/641,216 filed May 1, 2012, which is incorporated herein by reference.

### BACKGROUND OF THE INVENTION

This application is directed to a system that enables health care institutions and other institutions that have medical related information about a patient to electronically communicate that information to third parties who are designated by the patient.

### SUMMARY OF THE INVENTION

One embodiment of invention includes a system for disseminating information relating to an individual, where the system includes a database that stores the information relating to the individual, a unique code generator that generates a unique code specific to the individual, a portal that identifies one or more third party individuals who are eligible to receive the information, a notification system that notifies the one or more third party individuals that information relating to the individual is available on the system, and a portal that allows the third party individuals to access the information relating to the individual on the system if the unique code is entered by the one or more third party individuals.

Another embodiment of the invention includes a system for disseminating health care information relating to a patient that includes a database that stores the health care information, where the database further stores diagnosis information that is specific to the patient, a portal configured to save contact information for one or more third party individuals who are eligible to receive the information, a unique code generator that generates a unique code that is specific to the patient where the unique code is provided to only the patient and not the third party individuals, a notification system that notifies the one or more third party individuals that the health care information relating to the patient is available on the system, and a portal that allows the third party individuals to access the information relating to the individual on the system if the unique code is entered by the one or more third party individuals.

Yet another embodiment of the invention includes a system for sharing post-operative information relating to a specific patient, where the system includes a database that stores post-operative information relating to the patient, a portal configured enter contact information for one or more third party individuals who are eligible to receive the post operative information, wherein the system is configured to send post operative information to the one or more third party individuals at predetermined times, wherein the post operative information being sent to the one or more third party individuals at a particular time includes information that is specific to the patent's recovery at that time.

### BRIEF DESCRIPTION OF THE DRAWINGS

FIG. 1 is a network schematic.

FIG. 2 is a screenshot of one embodiment of the system.

FIG. 3 is a screenshot of another embodiment of the system shown in FIG. 2.

FIG. 4 is a screenshot of yet another embodiment of the system shown in FIG. 2

FIG. 5 is a screenshot of yet another embodiment of the system shown in FIG. 2.

FIG. 6 is a screenshot of yet another embodiment of the system shown in FIG. 2.

### DETAILED DESCRIPTION

While the invention is susceptible to various modifications and alternative forms, specific embodiment thereof has been shown by way of example in the drawings and will be described in detail below. It should be understood, however that it is not intended to limit the invention to the particular forms disclosed, but on the contrary, the invention is to cover all modifications, equivalents, and alternative falling within the spirit and the scope of the invention.

The invention is directed to a system disseminating medical related information regarding a patient to authorized third parties. Specifically, this application is directed to a system with a portal that allows health care professionals, such as physicians, nurses, occupational therapists, and the like, to upload information related to a particular patient. This information may include medical history, diagnoses, medication lists, current vital information, upcoming appointments, therapy schedules, and the like. The system enables the patient to confidently share this information with certain individuals, such as friends, family members, and the like. This dissemination of information allows the individuals to form a “circle” of care around the patient. These individuals may elect to receive updated information about the patient and also notifications regarding upcoming events, such as follow-up appointments.

The figures disclose a communication system that is designed to address preventable hospital readmissions and compliance rates of elderly patients and to enable patients and users of the system to communicate with one another and with other third parties via social media outlets. This system is designed to encourage the patient to comply with his/her post-operative care plan by involving family and loved ones in that plan. The system also allows family and loved ones to keep current on the status of care of the patient after being released from the hospital regardless of where the loved one is located.

The system operates as follows. The discharge nurse, or patient, enters the patient condition (e.g. pneumonia, heart surgery) and patient information into the system. The entry includes the cell phone numbers of the individuals the patient would like to include in the network. The basic information is then entered, such as appointment dates for the next 4-6 weeks and uploads the prescription list.

The system then through text messaging, or email, alerts the member of their enrollment and begins to provide pertinent information relating to the care of the patient. The system is configured to be HIPAA complaint. The system has a custom post-op treatment/care plan that typically comprises the information that is provided to the patient upon discharge. This information is then disseminated via text messages, or email, to the members to keep them apprised of the expected rate of recovery (and things to watch out for) that is keyed to the patient's discharge date. The messages may include care that is time sensitive such that the messages relate to the expected progress of the patient post discharge.

In addition, the system sends out appointment alerts to the members to notify them of the patient's upcoming appointment and to help coordinate with logistics. The system will also allow the members to access the medication list and common questions surrounding each medication in order to help the patent through the recovery process. Finally, the system will provide reminders of when refills are required or when a particular medication is no longer required.

The content of the alerts or conditions can be uploaded by the medical provider or other third party through the system. The content may include videos, articles, other helpful information relating to the care of the patient. The types of conditions may also be supplemented by the system operator.

The benefits of this system is three-fold: (1) it provides the patient with the support and care they need as they recover (emotional support); (2) it seamlessly involves loved ones in the care process regardless of where the individual is located; and (3) finally, it helps with patient compliance (and reduces readmissions) through: educating the members of warning signs, keeping the members involved in the care (reduce missed appointments, missing medication, etc.).

In addition, the system allows patients and other members to communicate with each other via a common communication device, such as a message board, or via social media outlets, such as Facebook, Twitter, and the like. In addition, the members may also communicate with other members, not necessarily involved in the care of the patient, to communicate with other members who are involved in the care with other patients via social media to discuss common topics, such as issues relating to care or medical condition. The patients themselves may also use the system to communicate with other members via a social media platform or message board.

The system may also be configured to incorporate information available on the internet into the system such that to allow patients or members to access this information via the system. The information may be relevant to the care of the patient.

This system can be easily adaptable to other services that require the dissemination of confidential information. Therefore, this application is intended to cover all such services, some of which are stated above, but will be illustrated using of medical information relating to a patient as an example.

As shown in FIG. 1, the system will communicate over a computer network 10, which may be any type of computer network that may interconnect a plurality of user devices 12, 14. Of course, any number of user devices may be connected to the computer network 10 and the invention should not be construed as limited as herein described. Further, the computer network 10 may be, for example, the internet wherein a plurality of remote user devices are connected via a telephone network or other like network to each other. In addition, the computer network 10 may be an intranet wherein the plurality of user devices 12, 14 are connected via a network internal to an organization, such as a business, institution or the like. For example, the network may be connected via a LAN network. However, any computer network may be utilized that may be apparent to those skilled in the art. It can be appreciated that the information may be communicated to an individual through other means, such as a mobile application, e.g. i-phone, or any web enabled browser. Herein, the phrase “connected” is defined to mean directly coupled to or indirectly coupled through one or more intermediate components. Such intermediate components may include both hardware and software based components. Variations in the arrangement and type of the components may be made without departing from the spirit or scope of the claims as set forth herein. Additional, different or fewer components may be provided.

The user devices 12, 14 may be a computing device which allows a user to connect to a network 104, such as the Internet. Examples of a user device include, but are not limited to, a personal computer, personal digital assistant (“PDA”), cellular phone, or other electronic device. The user device 12, 14 may be configured to allow a user to interact with the server 16 or other components of the system 20, such as the database 18. The user device 12 may include a keyboard, keypad or a cursor control device, such as a mouse, or a joystick, touch screen display, remote control or any other device operative to allow a user to interact with the system 20 via the user device 12. In one embodiment, the user device 12 is configured to request and receive information from the system 20, such as a web page that is provided by the system 29. The user device 12 may be configured to access other data/information in addition to web pages over the network 10 using a web browser, such as INTERNET EXPLORER ® (sold by Microsoft Corp., Redmond, Wash.) or FIREFOX 0 (provided by Mozilla).

The server 16 may include the database 18 associated therewith. The database 18 may contain information relating to the patient. The information relating to the patient will be uploaded into the database 18 via a method discussed below. A patient seeking to access the system 20 to retrieve the information from the database 18 may use a computer 12, 14 or any other computer connected via the computer network 10 to access the database 18 via a website through the computer network 10. The network 10, therefore, allows for updates and access to those updates regarding information relating to the wait time and walk in availability for doctors, urgent cares, and hospital departments.

The server 16 may include a processor which may include a central processing unit (CPU), a graphics processing unit (GPU), a digital signal processor (DSP) or other type of processing device. The processor may be a component in any one of a variety of systems. For example, the processor may be part of a standard personal computer or a workstation. The processor may be one or more general processors, digital signal processors, application specific integrated circuits, field programmable gate arrays, servers, networks, digital circuits, analog circuits, combinations thereof, or other now known or later developed devices for analyzing and processing data. The processor may operate in conjunction with a software program, such as code generated manually (i.e., programmed).

The processor may be coupled with a memory, or the memory may be a separate component. The interface and/or the software may be stored in the memory. The memory may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory may include a random access memory for the processor. Alternatively, the memory may be separate from the processor, such as a cache memory of a processor, the system memory, or other memory. The memory may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory is operable to store instructions executable by the processor.

The functions, acts or tasks illustrated in the figures or described herein may be performed by the programmed processor executing the instructions stored in the memory. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor is configured to execute the software . The software may include instructions for analyzing and identifying a correlation.

The interface may be a user input device or a display. The interface may include a keyboard, keypad or a cursor control device, such as a mouse, or a joystick, touch screen display, remote control or any other device operative to interact with the system 20. The interface may include a display coupled with the processor and configured to display an output from the processor. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor, or as an interface with the software 20 for providing input parameters.

The present disclosure contemplates a computer-readable medium that includes instructions or receives and executes instructions responsive to a propagated signal, so that a device connected to a network can communicate voice, video, audio, images or any other data over a network. The interface may be used to provide the instructions over the network via a communication port. The communication port may be created in software or may be a physical connection in hardware. The communication port may be configured to connect with a network, external media, display, or any other components in system 20, or combinations thereof. The connection with the network may be a physical connection, such as a wired Ethernet connection or may be established wirelessly as discussed below. Likewise, the connections with other components of the system 20 may be physical connections or may be established wirelessly.

Any of the components in the system 20 may be coupled with one another through a network, including but not limited to the network 10. For example, the user devices 12, 14 may be coupled with the server 16 through a network. As another example, the user devices 12, 14 may be coupled with the database 18 through a network. Accordingly, any of the components in the advertising system 20 may include communication ports configured to connect with a network.

The network or networks that may connect any of the components in the system 20 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

The system 20, server 16, the database 18, and/or the user devices 12, 14 may represent computing devices of various kinds. Such computing devices may generally include any device that is configured to perform computation and that is capable of sending and receiving data communications by way of one or more wired and/or wireless communication interfaces, such as interface. For example, the user device 12, 14 may be configured to execute a browser application that employs HTTP to request information, such as a web page, from the server 16. The present disclosure contemplates the use of a computer-readable medium that includes instructions or receives and executes instructions responsive to a propagated signal, so that any device connected to a network can communicate voice, video, audio, images or any other data over a network.

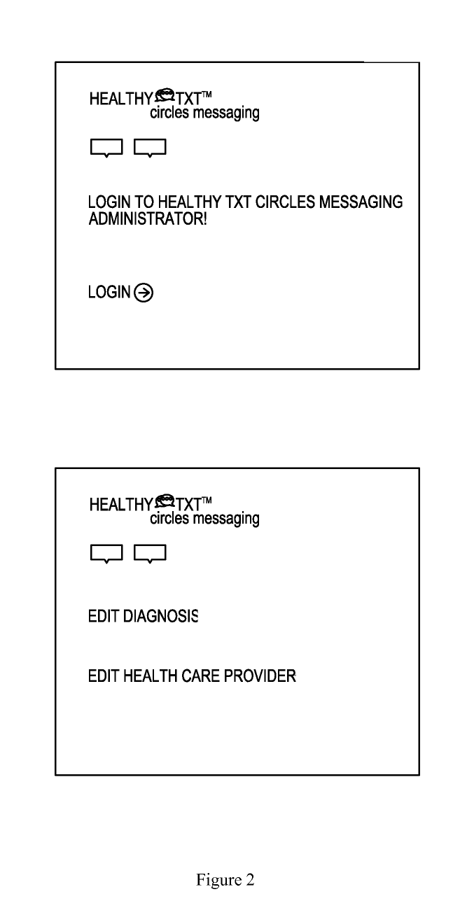

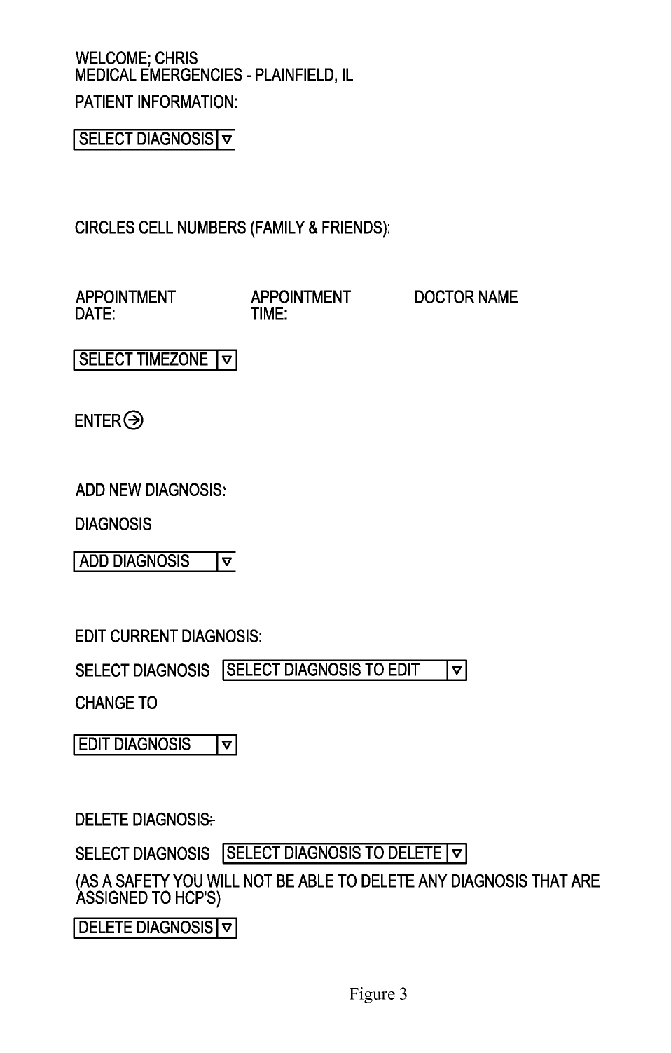

As shown in FIG. 2, the system 20, includes a portal 22. The portal 22, allows a health care professional or administrator (collectively “health care professional”) to access the system 20. The portal 22, enables the health care professional to access the system 20 to input or modify information relating to each patient. For a particular patient, the system 20 includes a diagnosis input 24 and a health care provider input 26. The portal 22 may reside on the user device 12. As better shown in FIG. 3, diagnosis input 24 allows the user to input new 30, edit 32, and remove 34 diagnosis for the patient. The diagnosis may mean a wide range of conditions or events and includes any type of medical condition that a patient may suffer from, including but not limited to diabetes, hypertension, heart disease (e.g. congestive heart failure), asthma, pneumonia, osteoporosis, and the like. In the alternative, the diagnosis may not be commonly or previously identified diagnosis and may only be identified by symptoms that the patient is or was experiencing. In another alternative, the diagnosis may be related to post operative care for the patient. For example, the diagnosis may be associated with the patients recovery from surgery, such as a bypass procedure, and medication list.

Associated with each diagnosis is a set of information related to the treatment, care (e.g. post operative care) and the diagnosis generally. This information may be unique to the patient or the health care provider or institution. This information may also be recovery specific such that it contains post-operative recovery information.

As further shown in FIG. 3, the portal 20 may also include a communication input portal 28. The communication input portal 28 is where the user inputs the health care information, such as the patient's diagnosis 36, the upcoming appointments for the patient 40, and the contact information 38 of the individuals that the patient would like to share the diagnosis, post operative information, medication information, and appointment information with. The contact information may include cellular phone numbers, email addresses, and the like. The number of individuals that the patient may share this information with is dependent on the patient and the health care professional and can vary.

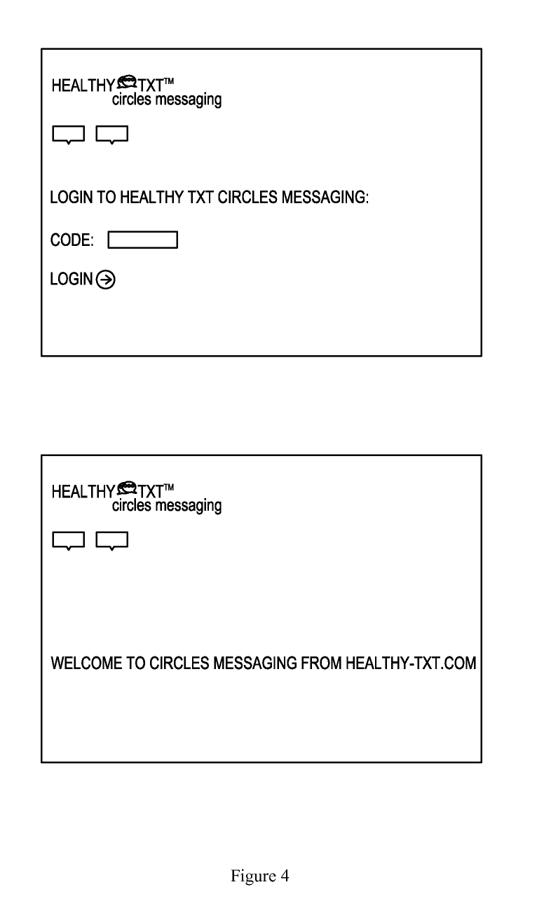

In operation, the system 20 generated a unique identifier code to the patient that allows the patient to access his/her diagnosis and health care information. The patient may share this code with the individuals whose contact information is inputted into the system. The system 20 sends a notification message to each of the individuals whose contact information 38 is inputted in the system 20 for a particular patient. The notification message informs each individual that he/she has been designated to receive diagnosis and health care information relating to a patient. The individual is instructed to visit a web page 42 with a login screen, as shown in FIG. 4, where the individual is instructed to input the code that is provided to the patient. The individual will not be able to access the patient's diagnosis and health care information without the code. The code may only be provided to the individual by the patient. In the alternative, a code may not be required and any individual designated by the patient will automatically receive the diagnosis and health care information for the patient.

The dissemination of health care information and diagnosis for the patient to the individuals will allow the individuals to keep current on the patient's condition, medication list, and progress. The system 20 encourages increased awareness and alertness about the patient's condition. This results in improved participation in caring for the patient amongst the individuals, which will result in improved compliance by, and outcomes for, the patient.

In the scenario where a code is required, once logged in, the individual may elect to receive updates about the patient includes changes in the appointment times, diagnosis and/or health care information from time to time. The updates may be sent via the mode of communication preferred by the individual. The updates may either direct the individual to a webpage of the system 20 to log in with the code to view this information or directly send the updated information directly to the individual's device. The system 20 may also include retrieval system whereby the individual may retrieve the code via e-mail, text message, or return phone call.

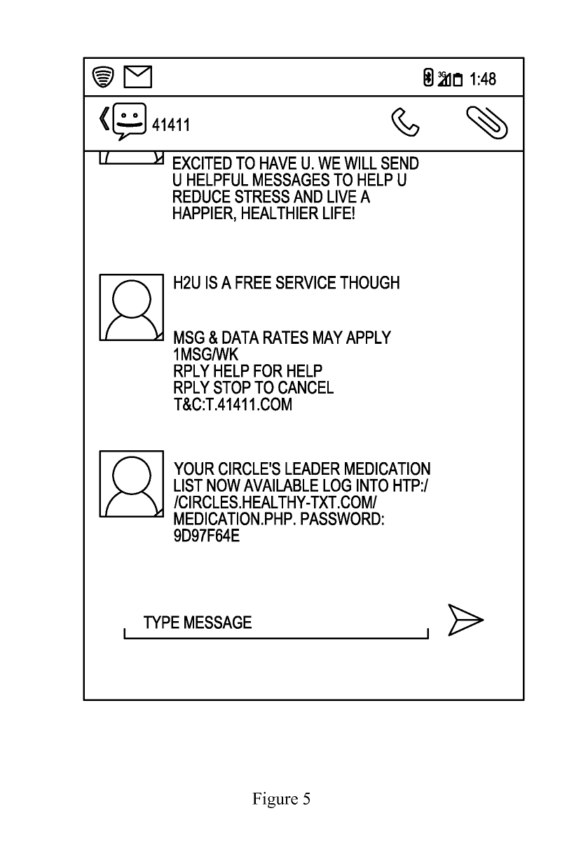

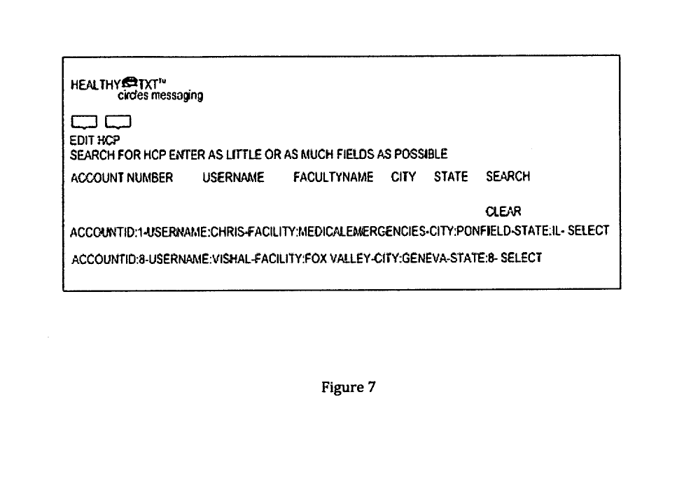

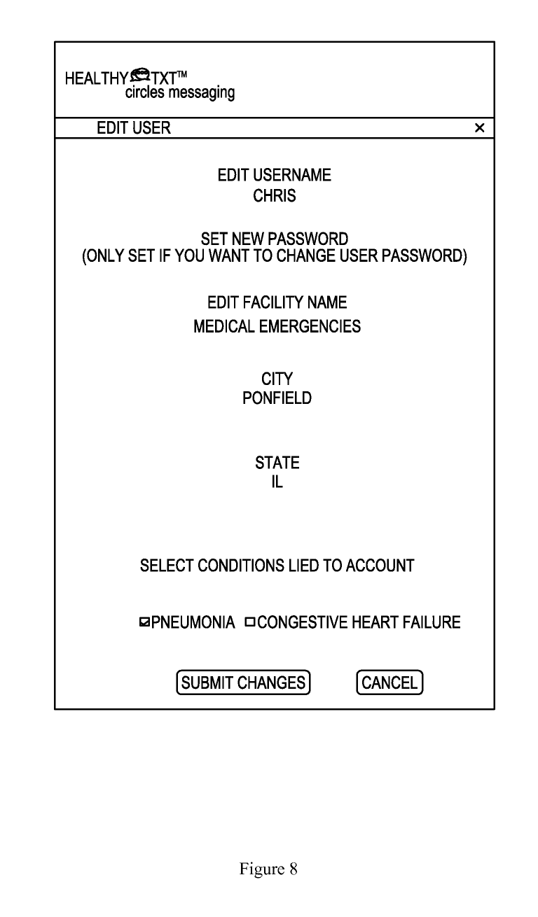

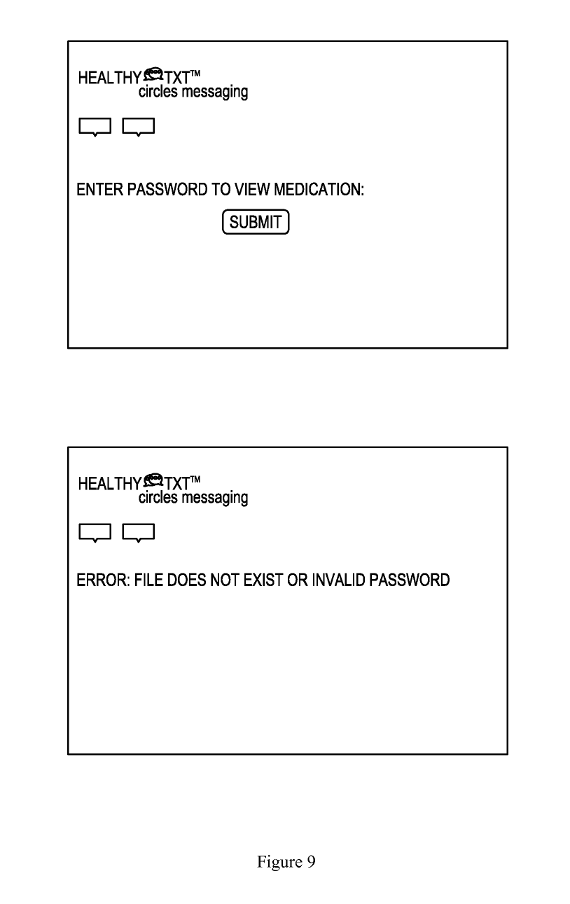

From time to time, the health care professional may elect to update the diagnosis and health care information, such as the medication list, relating to the patient via the health care portal 26. Under such a scenario, the system 20 will notify the patient in the mode preferred by the patient. For example, as shown in FIG. 5, the system 20 may send a SMS message 44 to the patient that may state the reason for the update (e.g. new medication list) and a code to view this information. The webpage 46, as shown in FIG. 4, will require the patient to input the code prior to viewing the updated information. In an alternative embodiment, the system may directly provide this information to the patient without a code.

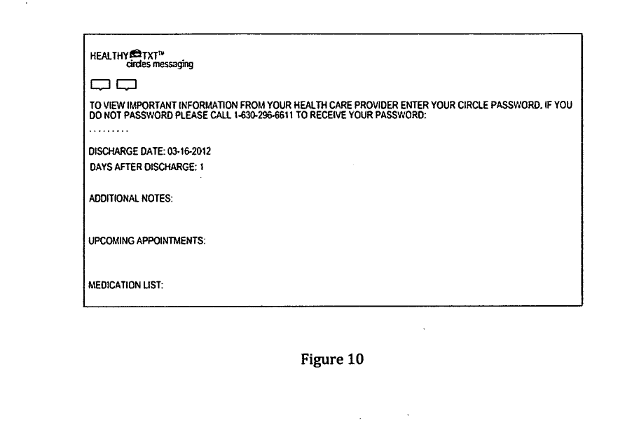

The system 20 may also include a patient-specific forum 48 as shown in FIG. 6 where the patient and the individuals selected to receive the patient's health care information and diagnosis may communicate with one another. The forum enables the individuals to keep apprised of the patient's progress and provides and opportunity for the patient to directly communicate with each of the individuals, either together or individually. There may be a section to post status updates or threads regarding the patient's care or logistics for caring for the patient. There may also be a link to the most current vital signs of the patient, his/her recovery, current medication list, current treating doctors, or any other health-related information.

In situations where the health care information is related to post-operative care, the system 20 will disseminate either notifications or actual recovery information for the patient to the individual(s) and/or the patient. For example, if the patient is recovering from ACL surgery, the system 20 will send periodic messages to the patient and/or individual(s) about the anticipated recovery progress for the patient. The system 20 may send out periodic messages, perhaps weekly or bi-monthly, with recovery-related information to educate the patient and/or individual(s) about the anticipated projected recovery for the patient. This information will assist the patient and/or individual(s) in maintain compliance with the desired recovery regimen and will alert them to potential deviations from the protocol that require attention from the health care professional. The system 20 is intended to provide early notification of any potential health issues before they mature into more serious and costly complications.

It is also contemplated that the system 20 will have an appointment reminder system, such that the system 20 will remind and individuals that patient of an upcoming appointment via an email or text message.

A “computer-readable medium,” “machine readable medium,” “propagated-signal” medium, and/or “signal-bearing medium” may comprise any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

1. A system for disseminating information relating to an individual, the system comprising:
a database that stores the information relating to the individual;
a unique code generator that generates a unique code specific to the individual;
a portal that identifies one or more third party individuals who are eligible to receive the information;
a notification system that notifies the one or more third party individuals that information relating to the individual is available on the system; and
a portal that allows the third party individuals to access the information relating to the individual on the system if the unique code is entered by the one or more third party individuals.

2. A system for disseminating health care information relating to a patient, the system comprising:
a database that stores the health care information, where the database further stores diagnosis information that is specific to the patient;
a portal configured to save contact information for one or more third party individuals who are eligible to receive the information;
a unique code generator that generates a unique code that is specific to the patient where the unique code is provided to only the patient and not the third party individuals;
a notification system that notifies the one or more third party individuals that the health care information relating to the patient is available on the system; and
a portal that allows the third party individuals to access the information relating to the individual on the system if the unique code is entered by the one or more third party individuals.

3. A system for sharing post-operative information relating to a specific patient, the system comprising:
a database that stores post-operative information relating to the patient;
a portal configured enter contact information for one or more third party individuals who are eligible to receive the post operative information, wherein the system is configured to send post operative information to the one or more third party individuals at predetermined times, wherein the post operative information being sent to the one or more third party individuals at a particular time includes information that is specific to the patent's recovery at that time.
